(19) United States
(12) Patent Application Publication
(10) Pub. No.: US 2012/0005622 A1
(43) Pub. Date: Jan. 5, 2012

(54) APPARATUS TO DISPLAY THREE-DIMENSIONAL (3D) USER INTERFACE

(75) Inventors: Woo Hyun PARK, Seoul (KR); Su Jin KIM, Seoul (KR)

(73) Assignee: PANTECH CO., LTD., Seoul (KR)

(21) Appl. No.: 13/114,377

(22) Filed: May 24, 2011

(30) Foreign Application Priority Data
Jul. 1, 2010 (KR) 10-2010-0063387

(51) Int. Cl. G06F 3/048

(52) U.S. Cl. 715/782

(57) ABSTRACT

An apparatus to display a three-dimensional (3D) User Interface (UI) includes a display panel to display a 3D UI comprising main menu polygonal cells; a sensing unit to sense a user selection of a target main menu polygonal cell; and a control unit to execute a function of the selected target main menu polygonal cell.

### CROSS-REFERENCE TO RELATED APPLICATION

This application claims priority from and the benefit under 35 U.S.C. §119(a) of Korean Patent Application No. 10-2010-0063387, filed on Jul. 1, 2010, which is incorporated by reference for all purposes as if fully set forth herein.

### BACKGROUND OF THE INVENTION

1. Field

The following description relates to an apparatus to display a three-dimensional (3D) User Interface (UI), and more particularly, to an apparatus to display the 3D UI that may display one or more menu items on a display screen using the 3D UI.

2. Discussion of the Background

Generally, a user terminal provides a variety of menu icons using a two-dimensional (2D)-based User Interface (UI). For example, on a conventional main screen of a user terminal, icons of downloaded applications may be uniformly arranged and displayed. Also, since the size of the screen of the user terminal may be limited, there may be a limit on the number of icons that may be displayed on a single screen. Thus, if the number of downloaded applications increases, the main screen of the user terminal may be expanded onto multiple pages. As a result, main screen may include multiple pages, which the user may have to view through to locate an application or a menu icon of choice, and the user may experience some inconvenience in locating the application or the menu icon of choice.

Further, if the user selects a main menu icon, an entire screen may be reconstructed with sub-menu icons corresponding to the selected main menu icon. Accordingly, in order to select another main menu icon after navigating to the sub-menu icons, the user may first navigate back to a home screen by selecting a back key at least once.

### SUMMARY

Exemplary embodiments of the present invention provide an apparatus to display a three-dimensional (3D) User Interface (UI).

Additional features of the invention will be set forth in the description which follows, and in part will be apparent from the description, or may be learned by practice of the invention.

Exemplary embodiments of the present invention provide an apparatus to display a three-dimensional (3D) User Interface (UI) including a display panel to display a 3D UI including main menu polygonal cells; a sensing unit to sense a user selection of a target main menu polygonal cell; and a control unit to execute a function of the selected target main menu polygonal cell.

Exemplary embodiments of the present invention provide an apparatus to display a three-dimensional (3D) User Interface (UI) including a display panel to display the 3D UI, wherein in the 3D UI includes multiples of selectable cells arranged in a geometric shape, a sensing unit to sense a user selection of a target folder, and a control unit to display a file list saved in the target folder on the UI.

Exemplary embodiments of the present invention provide an apparatus to display a three-dimensional (3D) User Interface (UI) including a display panel to display a main menu polygonal cell; a sensing unit to sense a user selection of the main menu polygonal cell; and a control unit to execute a function of the selected polygonal cell, wherein the executed function includes navigating to one or more corresponding sub-menus, or executing a corresponding application.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an apparatus to display a three-dimensional (3D) User Interface (UI) according to an exemplary embodiment of the invention.

FIG. 2 is a diagram illustrating a 3D UI to display one or more main menus according to an exemplary embodiment of the invention.

FIG. 3 is a diagram illustrating a 3D sub-UI to display one or more sub-menus corresponding to of a target main menu according to an exemplary embodiment of the invention.

FIG. 4A, FIG. 4B, and FIG. 4C are diagrams illustrating a method for operating a 3D sub-UI according to an exemplary embodiment of the invention.

FIG. 5 is a diagram illustrating a 3D UI and a 3D sub-UI according to an exemplary embodiment of the invention.

FIG. 6 is a diagram illustrating a 3D UI and a 3D sub-UI according to an exemplary embodiment of the invention.

FIG. 7 is a diagram illustrating a 3D UI and a 3D sub-UI according to an exemplary embodiment of the invention.

FIG. 8 is a block diagram illustrating an apparatus to display a 3D UI according to an exemplary embodiment of the invention.

FIG. 9 is a diagram illustrating a folder structure and a 3D UI displayed on a second display panel according to an exemplary embodiment of the invention.

FIG. 10 is a flowchart illustrating a method of displaying a 3D UI according to an exemplary embodiment of the invention.

FIG. 11 is a flowchart illustrating a method for displaying a 3D UI according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

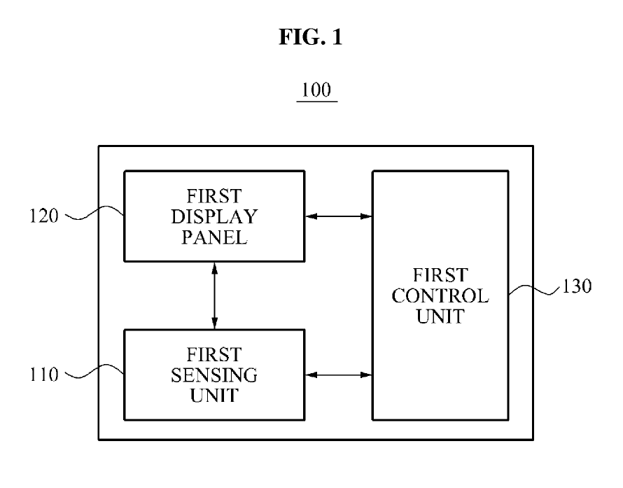

FIG. 1 is a block diagram illustrating an apparatus to display a three-dimensional (3D) User Interface (UI) 100 according to an exemplary embodiment of the invention.

The 3D display apparatus 100 of FIG.1 displays a UI in 3D, which may be applied to an electronic device to display the UI. In an example, the electronic device may include a smart phone, a mobile phone, a display device, a personal computer (PC), and the like. As shown in FIG. 1, the 3D display apparatus 100 includes a first sensing unit 110, a first display panel 120, and a first control unit 130.

In an example, the first sensing unit 110 may include at least one of a touch sensor to recognize a touch of the user and a proximity sensor to sense the movement of the user contact on the display panel 120. The touch sensor may sense the touch of the user. The proximity sensor may sense a user contact, such as a finger of the user, which may be moved on the surface of the first display panel 120. In an example, the movement of the user contact may include selection of a menu item which may be dragged across the surface of the first display panel 120.

The first sensing unit 110 may sense the finger of the user using at least one of an optical sensing scheme, a light blocking scheme, an electric field distortion sensing scheme, and a camera sensing scheme. The first sensing unit 110 may be equipped either on a surface of the first display panel 120 or inside of the first display panel 120.

The first display panel 120 may display, by the control of the first control unit 130, a two-dimensional (2D) UI or a 3D UI. In addition, the first display panel 120 may display various images that may be saved in the 3D display apparatus 100. More particularly, the first display panel 120 may display main menu items, such as icons or other representations, on a main 3D UI screen. Further, the first display panel 120 may display sub-menu items of the selected main menu item using the 3D UI as well. In an example, the main menu item and the sub-menu item may be displayed as a polygonal cell, an icon, a letter, or the like (hereinafter collectively referred to as “p-cell”).

Hereinafter, a UI for displaying a main menu will be referred to as a 3D UI, and a UI for displaying sub-menus will be referred to as a 3D sub-UI.

The first control unit 130 may execute a function, or may adjust a display status of the 3D UI and the 3D sub-UI according to the received user input. Assuming the main menu p-cell to be selected is an application, if the user selection of a main menu p-cell using the 3D UI is sensed, the first control unit 130 may execute the function of the selected main menu p-cell. In an example, the application may be an executable program, a file to viewed or played, or the like. On the other hand, if the main menu p-cell to be selected corresponds to a sub-menu structure, the first control unit 130 may adjust the display status of the 3D UI to display one or more sub-menu p-cells corresponding to the selected main menu p-cell on the 3D sub-UI. Hereinafter, a selected main menu p-cell will be referred to as a target main menu p-cell.

The first control unit 130 may display, on the first display panel 120, the 3D sub-UI that displays sub-menu p-cells corresponding to the target main menu p-cell. In an example, the sub-menu p-cells may be displayed on the 3D sub-UI. Further, a cross section of the 3D sub-UI may have a polygonal shape. In an example, the cross section of the 3D sub-UI may have similar polygonal shape as the polygonal cell of the 3D UI, if the main menu p-cell is displayed as a polygonal cell. The polygonal cell may be varied in shape. For example, the polygonal cell may be a hexagon shape, a beehive shape, a pentagon shape, and the like.

Also, the first control unit 130 may display the 3D sub-UI to be overlapped with the 3D UI.

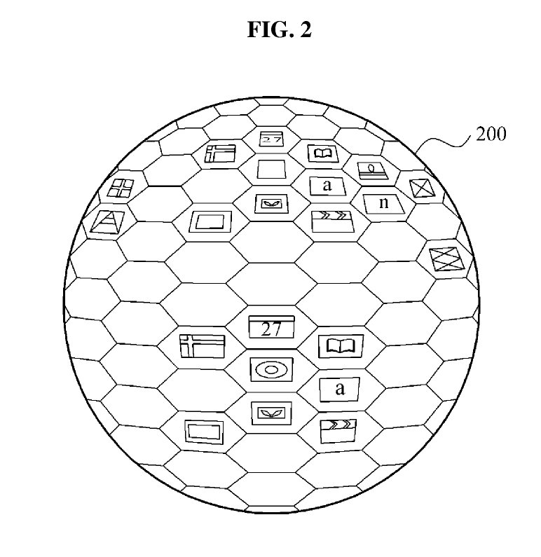

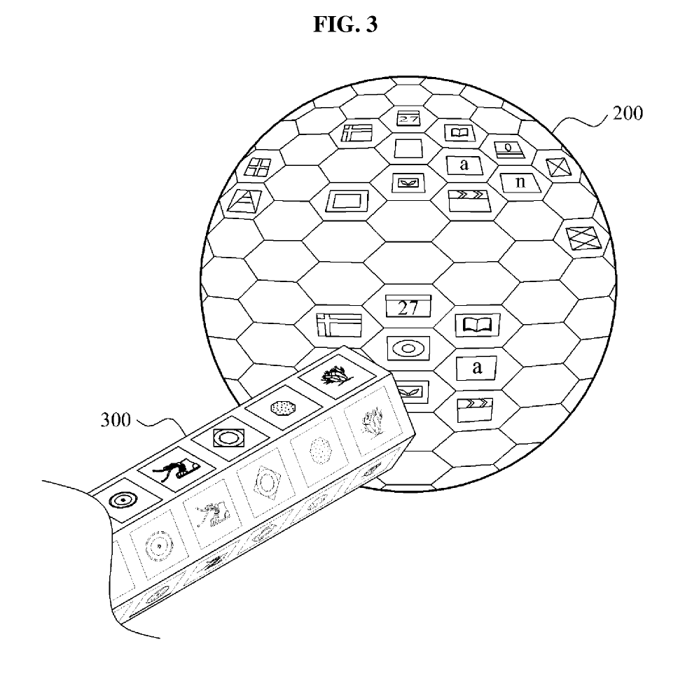

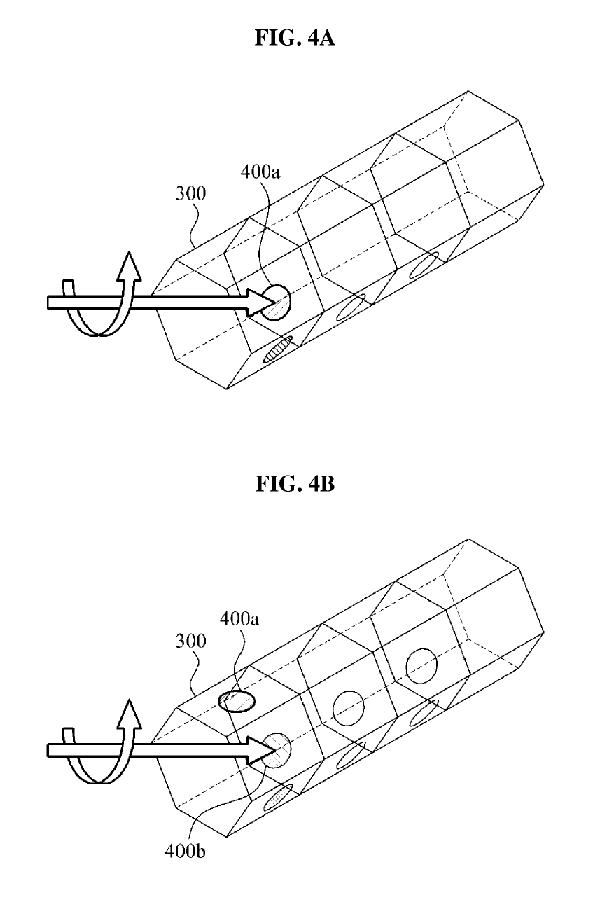

FIG. 2 is a diagram illustrating a 3D UI to display one or more main menus according to an exemplary embodiment of the invention. FIG. 3 is a diagram illustrating a 3D sub-UI to display one or more sub-menus corresponding to a target main menu according to an exemplary embodiment of the invention.

As shown in FIG. 2, a 3D UI 200 is displayed as a spherical globe, which may include one or more p-cells, more specifically, polygonal cells. One or more of the polygonal cells may display an icon, a text, or a combination of an icon and a text to represent various subfolders or applications. The user may browse the main menu polygonal cells provided by the 3D display apparatus 100 by touching and moving the 3D UI 200 similar to rotating a globe. More specifically, the user may touch a part of the 3D UI 200 with the user's finger or a touching apparatus, and drag the user's touch in the direction the user wants to see. For example, if the user drags the user's finger in a downward direction, the 3D UI 200 will scroll down accordingly. Likewise, the user may drag user's finger in an upward direction, right direction, left direction, diagonal direction, and the like and the 3D UI 200 will accordingly scroll in the corresponding direction.

If the 3D display apparatus 100 receives a user selection of a target main menu, the first control unit 130 may display, on the first display panel 120, the 3D sub-UI 300 of the selected polygonal cell as shown in FIG. 3. The target main menu may be selected by selecting a polygonal cell displaying the target main menu on the 3D UI 200. In an example, the polygonal cells displayed on 3D sub-UI 300 may be zoomed in and displayed if the polygonal cell is selected.

Further, a cross section of the 3D sub-UI 300 may be in a similar polygonal shape as the target main menu polygonal cell and the 3D sub-UI 300 may be displayed as a polygonal pillar having several sides, which are referred to as “pages.” In an example, if the polygonal pillar is a pentagon, the 3D sub-UI 300 may have 5 pages. Sub-menu p-cells of the target main menu polygonal cell may be displayed on a page of the 3D sub-UI 300. In an example, the sub-menu p-cell may be an icon, a text, or the like. If all the sub-menu p-cells are not displayed on a single page, the user may browse the sub-menu page by touching the left side or the right side of the single page to scroll the page to the left and to the right.

In addition, if one of the sub-menu p-cells displayed on the first page of the 3D sub-UI 300 is determined to be selected by the user, the first control unit 130 may rotate the 3D sub-UI 300 by a reference angle in a reference direction and display a different page displaying lower menu p-cells corresponding to the selected sub-menu p-cells.

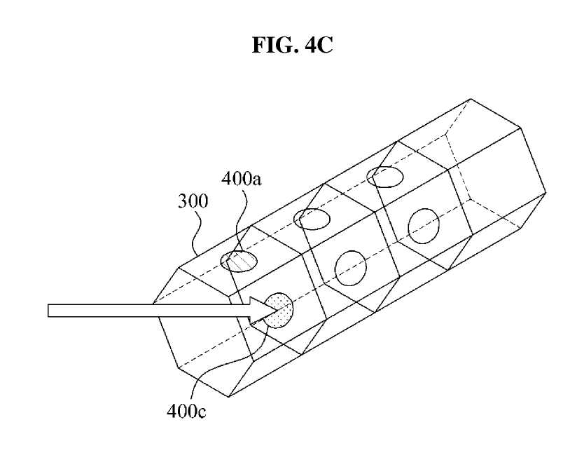

FIG. 4A, FIG. 4B, and FIG. 4C are diagrams illustrating a method for operating a 3D sub-UI according to an exemplary embodiment of the invention.

FIG. 4A, FIG. 4B, and FIG. 4C focus on the 3D sub-UI 300 to provide a concise description. A sub-menu p-cell 400a corresponds to a target main menu p-cell, which may be displayed on a first page among several pages of the 3D sub-UI 300. If a user selection of the sub-menu p-cell 400a is received, the first control unit 130 may rotate the 3D sub-UI 300 counterclockwise by a reference angle to display a second page instead of the first page. In an example, lower menu p-cell 400b corresponding to the selected sub-menu p-cell 400a may be displayed on the second page of the 3D sub-UI 300. Further, if the user selection of the lower menu p-cell 400b is received, the first control unit 130 may rotate the 3D sub-UI 300 again counterclockwise by the reference angle to display a third page instead of the second page. The third page of the 3D sub-UI 300 may display a lower menu p-cell corresponding to the selected lower menu p-cell 400b.

To navigate to a previous page of the 3D sub-UI 300, the user may touch and drag the 3D sub-UI 300 in a clockwise direction. If the clockwise drag is sensed, the first control unit 130 may display the previous page of the 3D sub UI 300 by rotating the 3D sub-UI 300 by the reference angle.

Referring back to FIG. 2, and FIG. 3, if the 3D sub-UI 300 is displayed and then a second main menu p-cell is selected from one or more main menu p-cells that may be displayed on the 3D UI 200, the first control unit 130 may remove the displayed 3D sub-UI 300 from the first display panel 120 and display sub-menu p-cells corresponding to the selected second main menu p-cell. That is, the second main menu p-cell may be selected in a state where the 3D sub-UI 300 may be displayed to allow user selection of a different main menu p-cell. More specifically, the second main menu p-cell may be selected from the 3D UI 200 without navigating back to the main menu by operating a separate back key. For example, if the user selects the second main menu p-cell from the 3D UI 200 in a sphere form, the first control unit 130 may automatically remove the activated 3D sub-UI 300 and reconstruct sub-menu p-cells corresponding to the selected second main menu p-cell using a second 3D sub-UI. Further, the first control unit 130 may zoom in on the second 3D sub UI if the second main menu p-cell is selected.

The 3D display apparatus 100 may use the aforementioned 3D UI 200 in a spherical shape, thereby displaying, on a single screen, a large number of main menu p-cells on the first display panel 120. The 3D display apparatus 100 may display corresponding sub-menu p-cells of one or more of the selected main menu p-cells on a single screen using a polygonal pillar. Also, the 3D display apparatus 100 may display the main menu p-cells and the corresponding sub-menu p-cells on a single screen in a 3D form. Accordingly, the user may select a main menu p-cell from a sub-menu p-cell selection screen without switching back to the main menu screen, allowing the user to navigate from one menu to another menu with a simple operation.

In addition, the 3D display apparatus 100 may also sense an operation of the user using an acceleration sensor. The acceleration sensor may sense a moving direction of the 3D display apparatus 100. In an example, the user may operate the movement in selecting a main menu p-cell by tilting the 3D display apparatus 100 in a left, right, forward, or backward direction. Accordingly, if the 3D display apparatus 100 is tilted in the left direction, the movement on the screen may move in the same direction. In addition, if the 3D display apparatus 100 is then stopped by a snapping motion or a bouncing motion, the 3D display apparatus 100 may execute the selected menu p-cell, and thereby the user may use the menu without a separate touch.

In addition, the 3D display apparatus 100 may rotate the 3D UI, by tracing an eye movement of the user, which may control the movement on the screen to select a specific p-cell in a direction of the user eye movement.

Further, if the user sets up a desired rotation direction using a compass application installed in the 3D display apparatus 100, the 3D display apparatus 100 may rotate the 3D UI according to the set rotation direction. These methods may be used if navigating from the displayed page to the previous page or the next page.

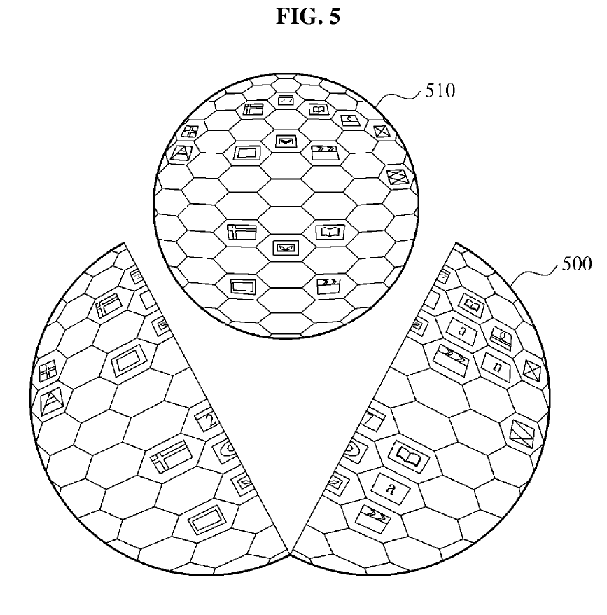

FIG. 5 is a diagram illustrating a 3D UI and a 3D sub-UI according to an exemplary embodiment of the invention.

In FIG. 5, if the user selects a target main menu p-cell, the first control unit 130 may display, on the first display panel 120, a 3D sub-UI 510 in the same spherical shape as a 3D UI 500. In an example, the first control unit 130 may display the 3D sub-UI 510 either to be located inside the 3D UI 500 or to be protruded from the inside of the 3D UI 500 as illustrated in FIG. 5. The 3D sub-UI 510 may display sub-menu p-cells corresponding to the selected target main menu p-cell.

The first control unit 130 may display the 3D sub-UI 510 in a spherical shape and display the 3D sub-UI to appear as though the 3D sub-UI protrudes from the 3D UI 500. If one of the sub-menu p-cells displayed on the 3D sub-UI 510 is selected, the first control unit 130 may display a lower menu UI with lower menu p-cells (3D sub-sub UI) corresponding to the selected sub-menu p-cell in a new spherical form. In case of navigating back to an upper menu screen, the user may navigate to the upper menu screen by touching the UI corresponding to the upper menu screen.

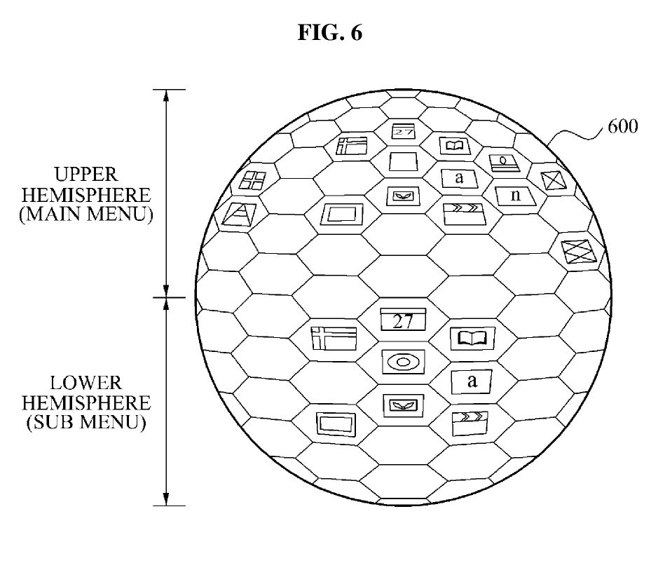

FIG. 6 is a diagram illustrating a 3D UI and a 3D sub-UI according to an exemplary embodiment of the invention.

Referring to FIG. 6, the first control unit 130 may display one or more main menu p-cells on an upper hemisphere of a 3D UI 600 and display one or more sub-menu p-cells corresponding to a target main menu p-cell on the lower hemisphere. Thus, the user may respectively control the upper hemisphere and the lower hemisphere of the 3D UI 600. In an example, if the user selects a sub-menu p-cell displayed on the lower hemisphere, one or more lower menus p-cells corresponding to the selected sub-menu p-cell may be displayed either as a part of the lower hemisphere or on a new spherical globe.

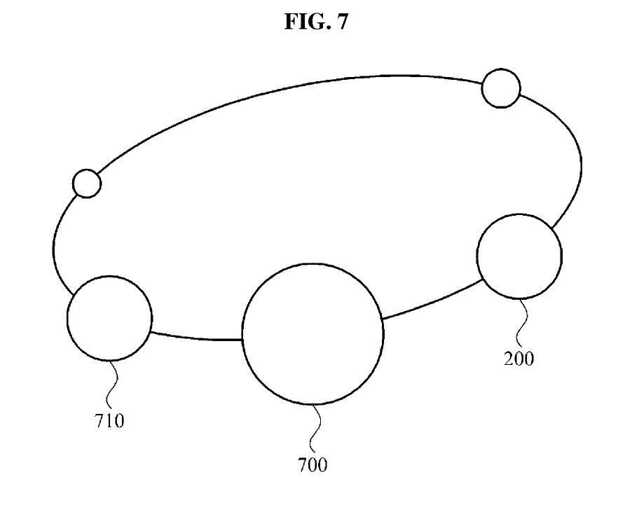

FIG. 7 is a diagram illustrating a 3D UI and a 3D sub-UI according to an exemplary embodiment of the invention.

Referring to FIG. 7, if a target main menu p-cell is selected from the 3D UI 200 as shown in FIG. 2, the first control unit 130 may construct the selected target main menu p-cell and a corresponding one or more sub-menu p-cells in a shape of a planetary system and display the selected target main menu p-cell and the sub-menu p-cells. That is, if a target main menu is selected, the first control unit 130 may zoom out the 3D UI 200 of FIG. 2, and generate, in a spherical form, a 3D sub-UI 700 displaying the sub-menu p-cells corresponding to the selected target main menu p-cell and zoom in on the 3D sub-UI 700. In an example, the sub-UI 700 that is zoomed in on may be displayed similarly to the 3D UI 200 of FIG. 2. Furthermore, the first control unit 130 may construct a planetary display by connecting the 3D UI 200 and the 3D sub-UI 700 with a stripe. If the user selects a sub-menu p-cell displayed on the 3D sub-UI 700, the first control unit 130 may display one or more lower menu p-cells of the selected sub-menu p-cell using a 3D lower UI 710 in a new spherical shape. Here, the first control unit 130 may zoom out the 3D UI 200 and the 3D sub-UI 700 and zoom in the 3D lower UI 710 and display the 3D lower UI 710.

In addition, the 3D UI in the spherical shape as described with reference to FIG. 1, FIG. 2, FIG. 3, FIG. 4, FIG. 5, FIG. 6, and FIG. 7 may be used if displaying an item of a web shopping mall. For example, if multiples of registered items are displayed on a web page of a web shopping mall, the registered items may be displayed in polygonal cells of a 3D UI, which may be displayed in a spherical form. More particularly, if the registered items are managed according to a category for one or more items, the user may search and access a target item without performing a separate scroll. For example, if the target item was a particular make and model of a shoe, a main menu p-cell may be designated a category of “shoes” and the corresponding sub-menu p-cells may include brands, price range, color, style and the like.

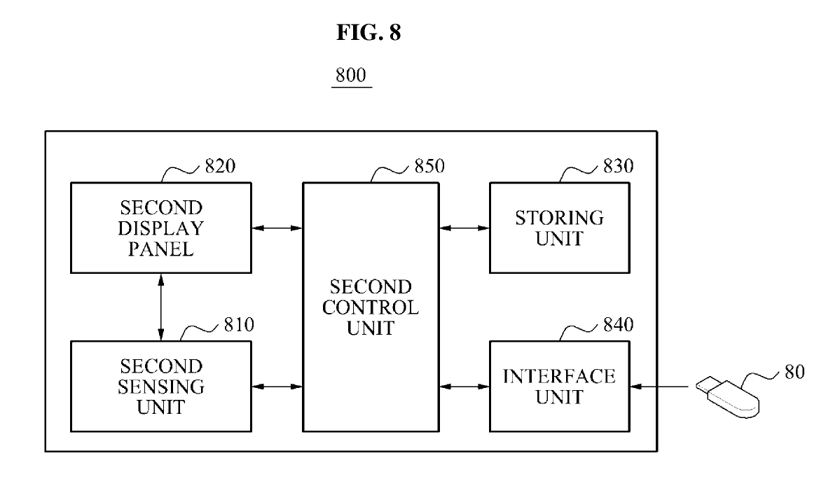

FIG. 8 is a block diagram illustrating an apparatus to display a 3D UI 800 according to an exemplary embodiment of the invention.

As shown in FIG. 8, the 3D display apparatus 800 includes a second sensing unit 810, a second display panel 820, a storing unit 830, an interface unit 840, and a second control unit 850. The second sensing unit 810 and the second display panel 820 are similar to the first sensing unit 110 and the first display panel 120 of FIG. 1 and thus, further detailed description with respect to those units will be omitted here.

The second sensing unit 810 may recognize a touch of the user. The second sensing unit 810 may sense a selection of the user with respect to a selected target folder among multiple folders displayed on the second display panel 820.

The second display panel 820 may display, by the control of the second control unit 830, a two-dimensional (2D) User Interface (UI) or a three-dimensional (3D) User Interface (UI). The second display panel 820 may display one or more of folders including the storing unit 830 or an external memory 80 using the 3D UI. That is, the second display panel 820 may display files stored in the storing unit 830 or the external memory 80, for one or more folders using the 3D UI.

The storing unit 830 may store a control program, an application program or user data which may be used to execute an operation of the 3D display apparatus 800. The user data may be a file that may be stored according to a received user command. In an example, the user data may include, multimedia content, such as a movie, a photo, a music file, and the like. In addition, the user data may include text format data, such as a document. The storing unit 830 may be an internal memory.

The interface unit 840 may provide an interface with the external memory 80. The external memory 80 may be a removable memory, for example, a Universal Serial Bus (USB) memory, a Hard Disk Drive (HDD), a flash memory, and the like. In addition, the external memory 80 may be a memory located in a server, which may be accessed through a network.

The storing unit 830 and the external memory 80 may include one or more folders and at least one file that may be stored in one or more folders.

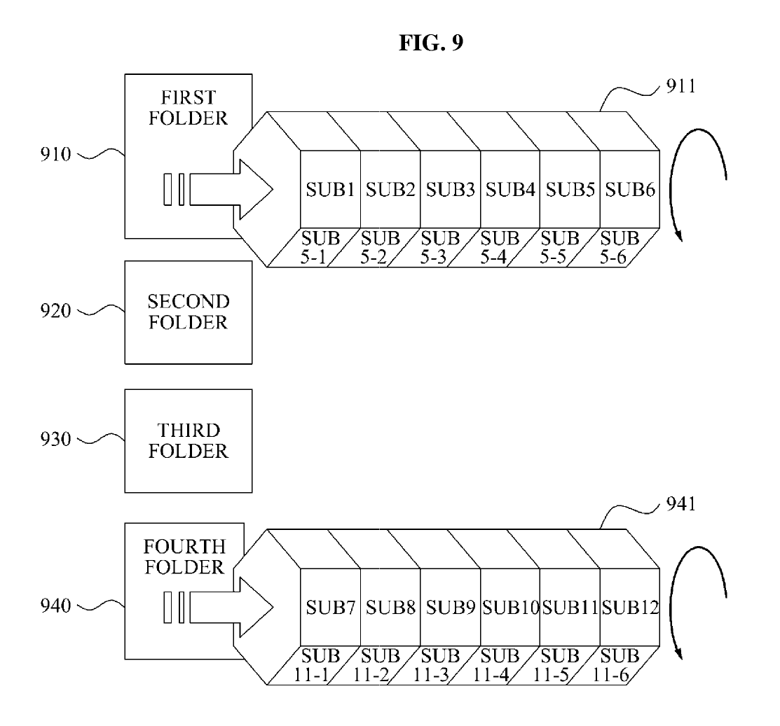

The second control unit 830 may execute a function corresponding to a sensing result of the second sensing unit 810 or adjust a display status of the 3D UI. Assuming the folder to be selected contains an application, if the user selection of the folder containing the application is sensed, the second control unit 830 may execute the function of the selected folder. On the other hand, if the folder to be selected corresponds to a sub-folder structure, then the second control unit 830 may display, on the second display panel 820, a file list stored in a target folder using the 3D UI as illustrated in FIG. 9. The target folder is a folder selected, by the user, from one or more folders. If the user drags the displayed 3D UI clockwise or counterclockwise, the second control unit 830 may rotate the 3D UI accordingly at a reference angle, and the user may thereby browse the file list.

FIG. 9 is a diagram illustrating a folder structure and a 3D UI displayed on the second display panel 820 according to an exemplary embodiment of the invention.

As shown in FIG. 9, the external memory 80 includes a first folder 910, a second folder 920, a third folder 930, and a fourth folder 940. In an example, if a target folder is selected, the second control unit 830 may activate a 3D UI 911 displaying a list of lower folders or a list of files which may be stored in the target folder. The target folder may be selected by receiving a user input.

Hereinafter, a file list, which references a list of files that may be stored in a folder, may be described as an example. Also, ‘activation’ may refer to an operation to display the 3D UI 911 on the second display panel 820.

The second control unit 830 may activate the 3D UI 911, which may be displayed as a polygonal pillar. The polygonal pillar may include one or more p-cells and one or more pages. In a p-cell, a name of a file or a sub-folder may be displayed. For example, the name of the file or a sub-folder may be displayed as “SUB1,” “SUB2,” “SUB3,” “SUB4,” “SUB5,” and “SUB6” as illustrated by FIG. 9. If the file SUB5 is selected, the second controller 830 may display, on another page of the 3D UI 911, sub-files or folders. In an example, “SUB5-1,” “SUB5-2,” “SUB5-3,” “SUB5-4,” “SUB5-5”, and “SUB5-6,” corresponding to the selected file “SUB5” may be displayed as illustrated by FIG. 9.

The second control unit 830 may display a 3D UI as a polygonal pillar with respect to the first folder 910, the second folder 920, the third folder 930, and the fourth folder 940. Accordingly, the user may skip a procedure to terminate the currently activated folder 910 and activate the second folder 920. For example, where the first folder 910 corresponds to a picture folder and the fourth folder 940 is a music folder, if the user touches the first folder 910 and the fourth folder 940, the second control unit 830 may activate the file lists which may be stored in the first folder 910 and the fourth folder 940 using 3D UI 911 and 3D UI 941.

Further, the second control unit 830 may display, on the second display panel 820, the file list stored in the target folder in a thumbnail view. More specifically, the 3D UI 911 and 3D UI 941 may represent a picture of a video, which may be displayed in a thumbnail view.

Also, the second control unit 830 may execute functions with respect to the selected files, if at least two folders are activated on the 3D UI via a multi-touch operation. That is, the user may select one or more files from a number of categories on a single screen.

In an example, assuming the folders to be selected corresponds to sub-folder structures, if at least two target folders are selected, such as the first folder 910 and the fourth folder 940, the second control unit 830 may display a file list belonging to one or more of the two target folders on the second display panel 820. In an example, the first folder 910 and the fourth folder 940, using corresponding 3D UI 911 and 3D UI 941.

On the other hand, assuming the folder to be selected is an application, if the user selects at least two files SUB5 and SUB11 via a multi-touch operation, the second control unit 830 may execute functions with respect to the selected files SUB5 and SUB 11. In an example, the application may be an executable program, a file to viewed or played, or the like.

More specifically, if the 3D UI 911 with respect to the first folder 910, which may be a picture folder, and the 3D UI 941 with respect to the fourth folder 940, which may be a music folder, are activated and then the user selects desired files SUB5 and SUB11 via a multi-touch operation, the first control unit 130 may display a picture in the first folder 910 while playing a music file stored in the fourth folder 940.

In another example, if the second folder 920 stores contact information of one or more acquaintances, the 3D UI may display a list of the acquaintances. If the user selects multiple acquaintances from the acquaintance list displayed on the 3D UI, the second control unit 830 may send a mail, a message, and the like to the selected acquaintances or provide various functions such as a conference call and the like.

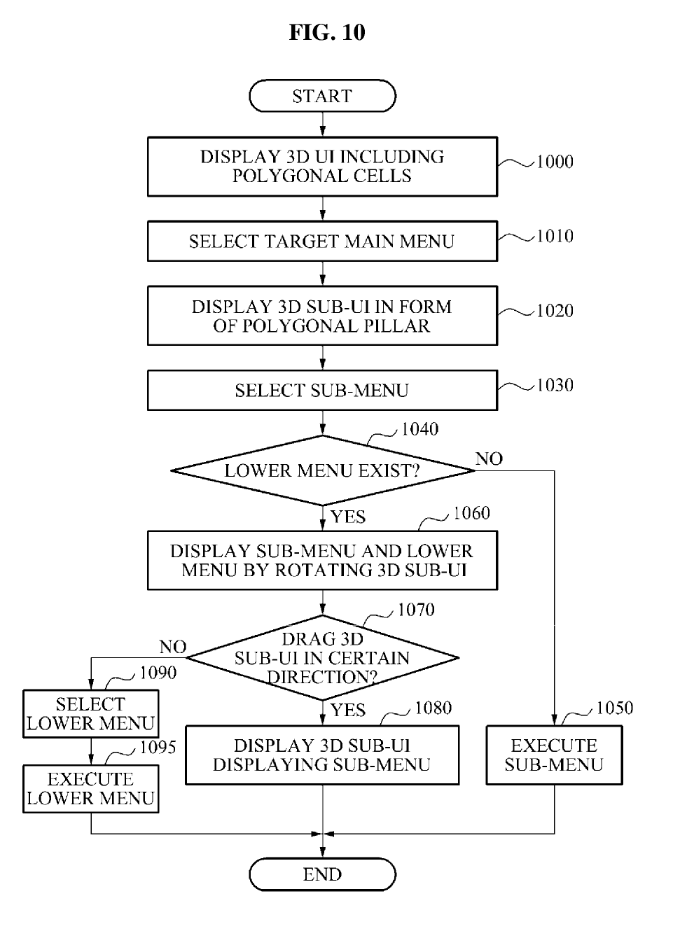

FIG. 10 is a flowchart illustrating a method of displaying a 3D UI according to an exemplary embodiment of the invention.

For convenience, FIG. 10 will be described as if the method was performed by the apparatus to display a 3D UI with reference to FIG. 1. However, the method is not limited as such.

In operation 1000, the apparatus to display a 3D UI may display, on a main screen, the 3D UI including one or more p-cells, such as polygonal cells. In an example, the polygonal cells may display icons of main menus.

In operation 1010, a selection of a target main menu polygonal cell from one or more main menu polygonal cells displayed on the 3D UI is received by the 3D UI displaying apparatus 100.

In operation 1020, the apparatus to display a 3D UI may display sub-menu p-cells corresponding to the selected target main menu polygonal cell using a 3D sub-UI in a polygonal pillar shape. In an example, the 3D sub-UI may have a similar polygonal cross section as the polygonal cell of the 3D UI. Accordingly, the 3D sub-UI may be displayed as the polygonal cell corresponding to the selected target main menu. In addition, the 3D sub-UI corresponding to the selected target main menu polygonal cell may be zoomed in.

In operation 1030, the user may select a target sub-menu p-cell from the displayed 3D sub-UI.

If a lower menu p-cell of the selected sub-menu is determined to be unavailable in operation 1040, the apparatus to display a 3D UI may execute the function of the selected sub-menu p-cell in operation 1050. In an example, if one or more of the lower menu p-cells corresponding to the selected sub-menu p-cell are determined to be unavailable, then the selected sub-menu p-cell may be an application or a program, which may be executed to provide a function.

However, if a lower menu p-cell of the selected sub-menu p-cell is determined to be available in operation 1040, the apparatus to display a 3D UI may rotate the 3D sub-UI by a reference angle and display a page including the lower menu p-cells corresponding to the selected sub-menu p-cell in operation 1060.

If the user drags the 3D sub-UI in a certain direction in operation 1070, the apparatus to display a 3D UI may display the 3D sub-UI displayed in operation 1080. That is, the apparatus to display a 3D UI may navigate back to an upper level to display the previous sub-menu page on the 3D sub-UI.

In addition, in operation 1090, if the user selects a p-cell from the lower menu p-cells displayed in operation 1060, the apparatus to display a 3D UI may execute the application or program corresponding to the selected p-cell in operation 1095.

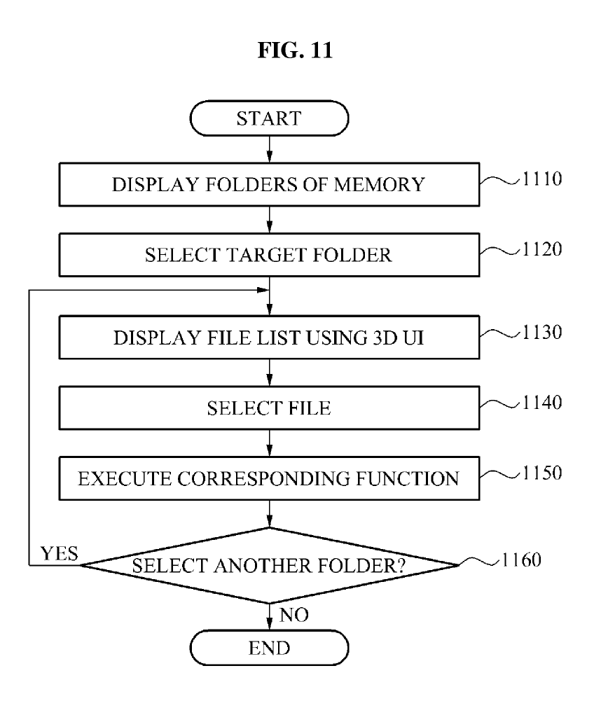

FIG. 11 is a flowchart illustrating a method for displaying a 3D UI according to an exemplary embodiment of the invention.

For convenience, FIG. 11 will be described as if the method was performed by the apparatus to display a 3D UI with reference to FIG. 1. However, the method is not limited as such.

In operation 1110, folders of an internal memory or an external memory are displayed.

In operation 1120, a selection of a target folder is received by the apparatus to display a 3D UI.

In operation 1130, the apparatus to display a 3D UI may display a list of files which may be stored in the selected target folder. In an example, the list of files may be displayed as one or more p-cells on a polygonal pillar.

In operation 1140, a selection of a target file is received on the 3D UI.

In operation 1150, the apparatus to display a 3D UI executes the corresponding function of the selected target file. If the target file is a sub-file that may be executed, and does not contain a sub-folder structure corresponding to the selected target file, then the apparatus to display a 3D UI may execute a function corresponding to the selected file. Alternatively, if the target file contains a sub-folder structure, then the apparatus to display a 3D UI may display the sub-folders corresponding to the selected target file.

In operation 1160, if a selection of a second folder is received by the apparatus to display a 3D UI from one or more folders displayed in operation 1110, the apparatus to display a 3D UI may execute operation 1130, operation 1140, and operation 1150 for the selected folder.

Without limitation, according to embodiments of the present invention, an apparatus to display the 3D UI may display one or more main menu p-cells on a display screen. Thus, even if a size of a display panel such as a Liquid Crystal Display (LCD) may be limited, a number of menus that may be displayed may not be as limited as the user may minimize a number of key manipulations to find a specific menu item, to navigate from page to page, and to navigate back and forth from main menu to sub-menu on a single screen without switching to a different screen.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to display a three-dimensional (3D) User Interface (UI), comprising:
a display panel to display a 3D UI comprising main menu polygonal cells;
a sensing unit to sense a user selection of a target main menu polygonal cell; and
a control unit to execute a function of the selected target main menu polygonal cell.

2. The apparatus of claim 1, wherein the control unit displays and zooms in on a 3D sub-UI on the display panel, wherein the 3D sub-UI displays sub-menu icons corresponding to the selected target main menu polygonal cell.

3. The apparatus of claim 2, wherein the control unit displays the 3D UI in a spherical shape on the display panel.

4. The apparatus of claim 2, wherein the control unit displays the 3D sub-UI on the display panel by overlapping the 3D sub-UI over the 3D UI.

5. The apparatus of claim 2, wherein the control unit displays the 3D sub-UI as a polygonal pillar comprising a plurality of sides on the display panel, wherein the polygonal pillar side is a first page to display a sub menu icon.

6. The apparatus of claim 5, wherein, if a target sub-menu icon is selected, the control unit rotates the 3D sub-UI by a reference angle and displays a second page comprising a lower menu icon corresponding to the selected target sub-menu on the display panel.

7. The apparatus of claim 2, wherein the 3D sub-UI is displayed in a similar polygonal shape as the selected target main menu polygonal cell.

8. The apparatus of claim 2, wherein, if a first sub menu icon corresponding to the selected target main menu polygonal cell is displayed and a second main menu polygonal cell is selected from the displayed 3D UI, the control unit removes the first sub menu icon from the display panel, and displays a second sub-menu icon corresponding to the selected second main menu polygonal cell on the display panel.

9. The apparatus of claim 3, wherein if the polygonal cell is selected, the control unit displays, the 3D sub-UI in a similar spherical shape as the 3D UI on the display panel, and displays the 3D sub-UI either to be located inside the 3D UI or to be protruded from the inside of the 3D UI.

10. The apparatus of claim 3, wherein the control unit displays the main menu polygonal cells on an upper hemisphere of the 3D UI and displays the sub-menu icon displayed on a polygonal cell corresponding to the selected target main menu polygonal cell on the lower hemisphere.

11. The apparatus of claim 3, wherein the control unit displays the selected target main menu polygonal cell and the corresponding sub-menu icon displayed on a polygonal cell as a planetary system on the display panel.

12. The apparatus of claim 1, wherein the function of the selected target main menu polygonal cell comprises display of sub-menu icon corresponding to the selected target main menu polygonal cell, or execution of an application or a file corresponding to the selected target main menu polygonal cell.

13. The apparatus of claim 1, wherein the main menu polygonal cell comprises a triangle, a rectangle, a pentagon, or a hexagon.

14. An apparatus to display a three-dimensional (3D) User Interface (UI), comprising:
a display panel to display the 3D UI, wherein in the 3D UI comprises a plurality of selectable cells arranged in a geometric shape;
a sensing unit to sense a user selection of a target folder; and
a control unit to display a file list saved in the target folder on the 3D UI.

15. The apparatus of claim 14, wherein the control unit displays, on the display panel, the file list saved in the selected target folder in a thumbnail view.

16. The apparatus of claim 14, wherein:
if at least two target folders are selected, the control unit displays a file list of the selected target folders using a corresponding 3D UI on the display panel, and
if at least two files are selected from the file list via a multi-touch, the control unit executes a function of the selected files.

17. The apparatus of claim 16, wherein the function of the selected file comprise display of a sub-folder corresponding to the selected folder, or execution of an program or a file corresponding to the selected folder.

18. An apparatus to display a three-dimensional (3D) User Interface (UI), comprising:
a display panel to display a main menu polygonal cell;
a sensing unit to sense a user selection of the main menu polygonal cell; and
a control unit to execute a function of the selected polygonal cell,
wherein the executed function includes navigating to one or more corresponding sub-menus, or executing a corresponding application.
